(19) United States
(12) Patent Application Publication
(10) Pub. No.: US 2002/0006260 A1
(43) Pub. Date: Jan. 17, 2002

(54) Preforms and optical fibers coated in alumina and/or silica

(75) Inventors: Gerard Orcel, Maison Laffitte (FR); Sophie Dubois, Saint Germain En Laye (FR); Jean-Florent Campion, Conflans St Honorine (FR)

Correspondence Address: SUGHRUE, MION, ZINN, MACPEAK & SEAS, PLLC, 2100 Pennsylvania Avenue, N.W., Suite 800, Washington, DC, 20037-3213, US

(73) Assignee: ALCATEL

(21) Appl. No.: 09/871,812

(22) Filed: Jun. 4, 2001

(30) Foreign Application Priority Data
Jun. 5, 2000 (FR) 00 07 143

(51) Int. Cl. G02B 6/22

(52) U.S. Cl. 385/128; 65/413

(57) ABSTRACT

The invention relates to an optical fiber preform comprising an optical core, optical cladding, and an outer sheath, in which the outer sheath includes a peripheral zone containing 20% to 100% by weight alumina and 80% to 0% by weight silica. Such a preform makes it possible to obtain optical fibers having improved mechanical strength and improved impermeability to hydrogen.

The present invention relates to an optical fiber preform including a coating based on silica (SiO₂) and/or alumina (Al₂O₃). Optical fibers are obtained by drawing a fiber from an optical fiber preform. Such a preform for silica-based optical fibers comprises a core and a sheath, the sheath comprising an inner portion which is in direct contact with the core and which is known as optical cladding, and an outer portion referred to as the outer sheath.

### BACKGROUND OF THE INVENTION

Preforms can be obtained by methods such as modified chemical vapor deposition (MCVD) or vapor axial deposition (VAD). When using MCVD manufacture, the core and the cladding are deposited inside a silica tube. A so-called “primary” preform is then obtained by collapsing the tube. Thereafter, the outer sheath is deposited on the outside of the primary preform.

Optical conductors are commonly used in the field of telecommunications. In silica-based optical fibers, information is generally transmitted in the form of light at a wavelength in the range about 1300 nanometers (nm) to 1625 nm. Such an optical fiber comprises an optically active portion constituted by the core which carries the major portion of the lightwave, and by the cladding, with the core and the cladding having different refractive indices, and usually also by an optically-inactive outer peripheral portion referred to as the outer sheath. For a preform that is obtained by MCVD, the cladding and the outer sheath are separated by a silica tube which can be optically active.

Since a fiber preform is drawn down to an optical fiber in a manner that preserves the geometrical proportions of their cross-sections, the terms “core”, “cladding” and “outer sheath” are also applied to the preform from which the optical fiber is made. Each fiber is protected by coverings of polymer material, and the protective coverings are, as a general rule, themselves covered in another covering of pigmented polymer.

The fragility of optical fibers gives rise to problems when handling them.

It is also known that optical fibers must not be exposed to hydrogen since hydrogen spoils their transmission properties. The extent to which the properties are spoiled increases with increase in the partial pressure of hydrogen to which the fiber is subjected.

For example, it is possible to introduce a hydrogen barrier by depositing the outer sheath in the presence of fluorine. Nevertheless, using fluorine-containing gases gives rise to non-negligible constraints both in terms of complying with the parameters of the method and in terms of avoiding pollution.

GB 2 145 840 discloses silica optical fibers in which the outer portion of the sheath is modified by the addition of an oxide that can be vitrified, preferably boron oxide, and/or at least one other oxide, including aluminum oxide. It recommends adding boron oxide and other oxides in suitable quantities, preferably in the range 1% by 20% by weight relative to the composition of the outer sheath, for the purpose of guiding undesired light. It does not specify the method for making the preform nor the structure of such a preform. Nevertheless, a covering with a thickness of the kind described in that document (17.5 micrometers (μm)) can reduce performance, particularly in traction testing.

Document JP 61 010 037 describes preforms comprising a core, inner cladding of doped silica, and an outer sheath made of silica together with an element selected from a list that includes aluminum. The layer is formed by decomposing chlorine-containing derivatives. Thereafter the preform is vitrified. Nevertheless, the deposit that is obtained by thermal decomposition degrades the mechanical strength of the fiber.

U.S. Pat. No. 4,540,601 discloses a method of coating fibers that have been obtained by being drawn from a preform. The fibers are then exposed to aluminum derivatives decomposed by pyrolysis into amorphous alumina. In addition to thermal decomposition leading to degraded mechanical properties of the fiber, that method suffers the drawback of requiring a fiber-drawing tower of considerable size. In addition, the thickness of the outer sheath cannot be controlled accurately.

There is therefore a need to provide optical fibers having improved mechanical strength while nevertheless being sufficiently impermeable to hydrogen. In addition, it would be advantageous for it to be possible to manufacture them at low cost.

Furthermore, it would be advantageous for the method of depositing a covering to be compatible with existing equipment, and in particular for it to require no modifications to an existing fiber-drawing tower.

It has been found that a preform covering having a composition of 20% to 100% alumina and 80% to 0% silica confers greater mechanical strength to fibers. Compared with making a deposit on the fiber, this covering has smaller roughness since it is melted during the fiber-drawing process, and in addition it can form a compression layer.

### OBJECTS AND SUMMARY OF THE INVENTION

The invention thus makes it possible to increase the mechanical strength of a fiber while conserving good impermeability to hydrogen.

The thickness of the layer can be controlled with great accuracy. In addition, the solution proposed is compatible with fiber-drawing speeds of several hundreds of meters per minute (m/min).

The invention thus provides an optical fiber preform comprising an optical core, optical cladding, and an outer sheath, wherein the outer sheath includes a peripheral zone comprising 20% to 100% by weight alumina and 80% to 0% by weight silica. The outer sheath has an inner portion in direct contact with the cladding or with the silica tube, depending on how the preform is made, and an outer portion in direct contact with the inner portion, and known as the “peripheral” zone.

In an embodiment, the peripheral zone comprises 50% to 100% by weight of alumina, and preferably 50% to 0% by weight of silica.

In another embodiment, the peripheral zone is made of alumina. In another embodiment, the peripheral zone comprises a composition of 50% by weight alumina and 50% by weight silica.

In an embodiment, said peripheral zone comprises a single layer. In another embodiment, it comprises a plurality of layers.

In yet another embodiment, the peripheral zone is at the periphery of the outer sheath.

In an embodiment, the peripheral zone is separated from the cladding by a silica tube.

The preform of the invention then has an outer sheath comprising the peripheral zone of silica and/or of alumina of the specified composition, which when transformed in almost exact geometrical proportion by fiber-drawing, gives rise to optical fiber of great strength while nevertheless retaining good impermeability to hydrogen. The outer sheath is generally of relatively small roughness since such a zone melts during fiber-drawing.

In addition, in an embodiment, because the outer sheath that is a precursor to the outer sheath of the optical fiber made from said preform is of moderate thickness, it is possible to obtain a compression zone. A compression zone is defined as presenting longitudinal stress having the effect of compressing the zone. The mechanics of how glass breaks shows that the main mechanism that leads to rupture lies in surface cracks being created and then propagating. If the surface of the fiber is put under compression, then such a crack-propagation phenomenon is avoided. Thus, forming such a zone greatly improves the mechanical properties of said optical fiber.

In a second embodiment, the thickness of the outer sheath that is a precursor for the outer sheath of the optical fiber made from said preform is so small that it is not possible to create a compression zone that is effective in increasing strength. Nevertheless, to our great surprise, the mechanical strength of such a fiber is still improved significantly.

The invention also provides a method of manufacturing a preform of the invention, the method comprising the steps of making a primary preform comprising an optical core and cladding; and forming a peripheral zone by external deposition, the peripheral zone comprising at least one layer comprising 20% to 100% by weight alumina and 80% to 0% by weight silica.

In an implementation of the method of the invention, the outer deposition operation is performed by plasma build-up. Making the preform by a lateral, external deposition technique, such as the plasma build-up technique, is known, and is described for example in patent application EP-A-0 450 465. In another implementation of the method of the invention, the external deposition is performed by outside vapor deposition (OVD). External deposition can also be performed by a sol-gel method, by impregnation, by vapor deposition, or by evaporation.

The preform of the invention is such that making an optical fiber from said preform is advantageously compatible with the fiber-drawing speeds that are most commonly used when making optical fiber in a fiber-drawing tower, where such speeds are generally of the order of several hundreds of meters per minute. In addition, such a deposit makes it possible to retain an existing fiber-drawing tower installation, since the invention is performed by acting on the preform. Furthermore, such deposition is compatible with industrial fiber-drawing conditions, and in particular with the tolerance required on the diameter of the optical fiber in order to regulate the fiber-drawing method.

Finally, the invention provides an optical fiber made by being drawn from a preform of the invention.

In an embodiment, the at least one layer of the outer sheath of the fiber obtained in this way has a thickness on the fiber lying in the range 1 nanometer (nm) to 1 μm.

### BRIEF DESCRIPTION OF THE DRAWINGS

The invention will be better understood and other characteristics and advantages will appear on reading the following description, given by way of non-limiting example and with reference to FIGS. 1 to 3.

FIG. 1 is a diagrammatic section view of a preform for an optical fiber in an embodiment of the invention.

FIG. 2 is a highly simplified diagram of a plasma build-up device in which one implementation of the method of the invention for making a preform is performed.

FIG. 3 is a diagrammatic section view of an optical fiber obtained from a preform in an implementation of the invention.

### MORE DETAILED DESCRIPTION

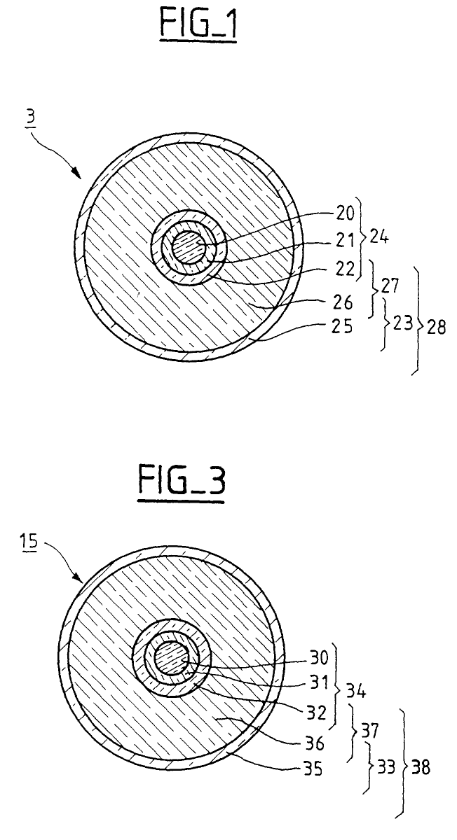

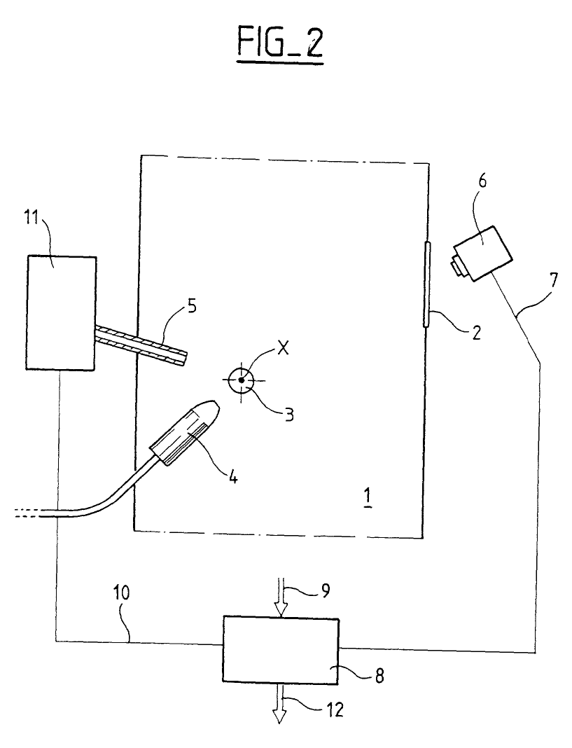

A primary preform 34, shown in FIG. 1, is made using the MCVD method, for example, by internally depositing optionally-doped silica-based layers to form an optical core 20 and cladding 21 in a tube 22 such that once the resulting coated tube is transformed by being collapsed, a bar is obtained which constitutes the primary preform 24, after which a (final) preform 3 is made by an external deposition operation based on silica and/or alumina in which layers are deposited externally on the primary preform 24 to constitute a build-up zone 23. It is preferable to use a tube 22 of ultrapure silica. Such external deposition is explained in FIG. 2 for the plasma build-up method.

FIG. 2 is a diagram showing a plasma build-up apparatus comprising an enclosure 1 having a transparent window 2, a preform 3 seen end-on, having a longitudinal axis X towards which there are pointed both a plasma torch 4 and a nozzle 5 for feeding build-up grains. It is possible to use natural silica or silica obtained synthetically from halogen-containing derivatives, for example. For alumina, it is possible to use particles of alumina of ultrapure quality with a maximum size that is typically a few tens of micrometers. It is preferable to use particles of pyrogenic alumina having a size of less than 0.1 μm so as to encourage uniform distribution of the particles in the peripheral zone. The use of grains containing the desired composition of alumina and silica is also possible.

Outside the enclosure 1, a CCD camera 6 placed behind the window 2 looks at the preform 3. It provides a measurement of the diameter of the preform at the location where it is looking, and this value is transmitted over a link 7 to apparatus 8 for controlling the build-up process. The apparatus 8 has a multiple connection 9 over which it receives other information concerning the conditions of the build-up process. Under the control of an internal program for running the build-up process, the apparatus 8 delivers a control value over an outlet link 10 to a control device 11 for enabling the nozzle 5 to be positioned relative to the preform 3 on the assumption that the grain flow rate is constant, and as a result, the nozzle 5 is positioned by moving said nozzle 5 along an axis parallel to the axis X. The apparatus 8 also delivers other control values on a multiple outlet connection 12, which values determine other aspects of the control process.

Such a preform can be made, for example, by the plasma build-up method as shown in FIG. 2. Silica particles are initially deposited by means of the nozzle 5 so as to form a portion 26 of the build-up zone 32 which is preferably of composition that is practically identical to that of the tube 22, i.e. extra pure silica. The formation of a peripheral zone 25 (see FIG. 1) begins when the silica and/or alumina is deposited in the form of grains on the primary preform 24. In the presence of the plasma, the grains are deposited merely under gravity from a feed duct which is a nozzle 5 that is moved in translation parallel to the primary preform 24. The grains of alumina and/or silica then melt and are vitrified at a temperature of about 2300° C. by means of the plasma. The build-up operation takes place in a closed cabin so as to provide protection against electromagnetic disturbances and against giving off the ozone that is emitted by the plasma torch 4.

Together the portion 26 and the tube 22 form an intermediate zone 27 of an outer sheath 28. Thereafter particles of alumina mixed with grains of silica, or where appropriate particles of alumina alone, are deposited by the nozzle 5 into a peripheral zone 25 of the build-up 23, constituting the outermost layers of the external deposit of the build-up zone 23. It is also possible to deliver silica via a first feed duct and particles of alumina via a second feed duct, with both ducts opening out close to the plasma torch 4 in the vicinity of the silica feed nozzle 5. As mentioned above, including alumina in the peripheral zone 25 of the build-up zone 23 makes it possible industrially during hot drying of an optical fiber 15 to obtain a fiber having improved resistance to hydrogen and improved mechanical strength compared with fibers without such a covering. The plasma build-up operation takes place in passes, from right to left and then from left to right, during which the plasma torch 4 and the nozzle 5 sweep along the length of the preform 3.

This provides a built-up preform 3 of the invention having a build-up zone 23 with a portion 26 and a peripheral zone 25. The outer sheath 28 of said preform 3 comprises the tube 22 and the build-up zone 23 itself comprising the portion 26 of the peripheral zone 25. In an embodiment of the invention, it is possible to dope the portion 26 of the build-up zone 23 with a quantity of alumina that is less than that obtained in the zone 25. The quantity of alumina particles introduced into the build-up relative to the quantity of silica grains is a function of the purity of the silica grains and of the tube 22 of the primary preform 24.

Nevertheless, the build-up preform 3 of the invention can also be obtained by deposition using the sol-gel method. Alumina and/or silica can be deposited, for example, using the method described by B.E. Yoldas in Ceramic Bulletin 54-3, 296 (1975). The alumina precursor is a clear sol obtained from aluminum alkoxides Al(OR)₃. The method comprises four steps: hydrolyzing aluminum alkoxides, peptizing hydroxides into a sol, forming the gel, and pyrolyzing the alumina gel. Another sol-gel method uses xerogel synthesis (L. Laby and L.C. Kelin, A. Turnianski and D. Avnir, Journal of Sol-Gel Science and Technology, 10, 177-184 (1997)).

All of the elements shown in FIG. 2 are well known to the person skilled in the art. Thus, the means for supporting the preform 3 and for driving it in rotation and in translation, a support carriage for the plasma torch 4 and the nozzle 5, and for driving them in translation parallel to the axis X, and means for evaluating the angular position of the preform 3 and the longitudinal position of the carriage are described, for example, in European patent application EP-A1-0 440 130. All of these means make it possible in conventional manner to move the preform 3 away from the torch 4 as the preform 3 is built up. Means for aiming the camera 6 at successive locations of the preform 3 during a measurement pass, which means can optionally be in the form of a second carriage whose displacement is coupled to the displacement of the first carriage, likewise form part of the state of the art.

In addition, the apparatus can have other commonly used elements.

The optical fiber 15 is fabricated by hot drawing from the built-up primary preform 3 of the invention using a fiber-drawing tension lying in the range 10 grams (g) to 250 g, and preferably lying in the range 30 g to 150 g. FIG. 3 is a diagrammatic section view of an optical fiber 15 obtained from the preform 3, in a manner that is almost exactly proportional thereto.

There can be seen an optical core 30 and cladding 31 forming the silica-based portion that is generally optically active. The zone 32 corresponds to the tube 22 of the preform 3. The inner zone 37 of the outer sheath 38 is formed by the zone 32 and a portion 36. The build-up zone 33 corresponds to the build-up zone 23 of the preform and comprises the portion 36 and the peripheral zone 35.

The following examples illustrate the invention but they do not limit the scope thereof.

### EXAMPLE 1

For the fiber of Example 1, a preform was subdivided into two portions, and one of the portions was coated in a layer of alumina using a sol-gel method. An alumina sol was prepared by hydrolyzing 136.6 g of aluminum tri-sec.butoxide (Al(OC₄H₉)₃, also known as ASB) in 1000 milliliters (ml) of deionized water at 80° C. with stirring for 30 minutes. The sol was peptized by adding 0.035 moles of nitric acid and continuing stirring at 80° C. under reflux for 7 days.

The preform was cleaned by being soaked in a solution of surfactant (Decon 90) diluted in distilled water in a ratio of 60/40 for 2 hours. It was rinsed in distilled water and then in acetone.

The preform was coated by immersion. For this purpose, the preform was immersed in the sol placed in a receptacle and then raised vertically from the sol at a controlled speed of 40 centimeters per minute (cm/min). The preform was then subjected to heat treatment at 80° C. for 1 hour.

### EXAMPLE 2

The deposition procedure of Example 1 was repeated three times on one-half of the preform, cleaning it each time between successive deposition operations. A preform was obtained that was coated in three layers of pure alumina.

### EXAMPLE 3

A silica/alumina sol was prepared by mixing 123 g of ASB and 123 g of partially hydrolyzed tetraethylortho-silicate (TEOS) in 900 ml of deionized water. The resulting precipitate was then peptized with 0.1 moles of nitric acid. The resulting solution was heated to 90° C. for 5 hours under reflux. The resulting translucent sol formed a transparent gel after 7 hours at ambient temperature.

Half of the preform was cleaned as described in Example 1 and then coated in two layers of the resulting gel.

A fiber was then hot drawn from the coated preforms. For each of the preforms, a non-coated reference fiber was also made by hot drawing.

The mechanical properties of the coated fibers of Example 1 to 3 were studied and compared with those of the reference fibers. For this purpose, the fibers of Examples 1, 2, and 3 were subjected to standardized traction strength testing. This consisted in pulling on a fiber and measuring the force required to break it. The test was performed on 50 fibers to obtain a statistical distribution. The median of the distribution is given in Table 1 below for the three treated fibers and for the corresponding reference fibers. It can be seen that the traction strength was increased by about 5% for fibers having a coating of alumina or of silica/alumina.

In addition, the Weibull slope was determined for the fibers obtained from the preforms of Examples 1 to 3.

Furthermore, the dynamic N factor was evaluated for the fibers. The results are also given in Table 1 below. It can be seen that the dynamic N factor increases for a pure alumina coating and does so with increasing thickness (Example 2).

The results for the fibers of Examples 1 to 3 are given in Table 1.

TABLE 1

| | Traction | | |
|---|---|---|---|
| Deposition | force [N] | Weibull slope | Nd factor |
| Reference | 60.5 | 7.0 | 22.0 |
| Example 1 | 63.4 | 9.3 | 26.3 |
| Reference | 61.0 | 13.6 | 22.5 |
| Example 2 | 64.2 | 54.3 | 28.9 |
| Reference | 59.7 | 40.6 | 20.3 |
| Example 3 | 63.3 | 33.5 | 20.6 |

In addition, the fibers were tested for hydrogen permeability over a period of 400 hours at 70° C. under a pressure of 1 atmosphere (1 atm=1.01325×10⁵ Pa) . The attenuation of the coated fiber of Example 2 at 1550 nm was 0.077 dB/km. Compared with the reference fiber for which the measured attenuation was 0.088 dB/km, that represents an improvement of about 12%.

TABLE 2

| | Increment in attenuation after H₂ test [dB/km] | | | | | |
|---|---|---|---|---|---|---|
| Deposition | 1240 nm | 1310 nm | 1385 nm | 1410 nm | 1550 nm | 1600 nm |
| Reference | 0.076 | 0.034 | 0.241 | 0.420 | 0.095 | 0.109 |
| Example 1 | 0.077 | 0.036 | 0.236 | 0.392 | 0.091 | 0.104 |
| Reference | 0.062 | 0.029 | 0.224 | 0.381 | 0.088 | 0.101 |
| Example 2 | 0.060 | 0.026 | 0.198 | 0.336 | 0.077 | 0.090 |
| Reference | 0.030 | 0.019 | 0.229 | 0.411 | 0.089 | 0.106 |
| Example 3 | 0.035 | 0.020 | 0.238 | 0.424 | 0.091 | 0.109 |

Naturally, the method of the invention is not limited to the Examples described above. In particular, it can be used with plasma build-up methods, and also with other methods such as OVD, sol-gel methods, impregnation methods, vapor deposition methods, or evaporation deposition methods.

1. An optical fiber preform comprising an optical core, optical cladding, and an outer sheath, wherein the outer sheath includes a peripheral zone comprising 20% to 100% by weight alumina and 80% to 0% by weight silica.

2. The preform of claim 1, in which said peripheral zone comprises 50% to 100% by weight alumina.

3. The preform of claim 1, in which said peripheral zone comprises 100% by weight alumina.

4. The preform of claim 1, in which said peripheral zone comprises 50% by weight alumina and 50% by weight silica.

5. The preform of claim 1, in which said peripheral zone comprises a single layer.

6. The preform of claim 1, in which said peripheral zone comprises a plurality of layers.

7. The preform of claim 1, in which said peripheral zone is separated from the cladding by a tube of silica.

8. The method of manufacturing a preform according to claim 1, the method comprising the steps of:
making a primary preform comprising an optical core and cladding; and
forming a peripheral zone by external deposition, the peripheral zone comprising at least one layer comprising 20% to 100% by weight alumina and 80% to 0% by weight silica.

9. A method according to claim 8, in which the external deposition step is performed by a sol-gel method.

10. A method according to claim 8, in which the external deposition step is performed by plasma build-up.

11. A method according to claim 8, in which the external deposition step is performed by OVD.

12. An optical fiber formed by hot drawing a preform according to claim 1.

13. The fiber of claim 12, in which said at least one layer of the peripheral zone had a thickness on the fiber lying in the range 1 nm to 1 μm.
